(19) United States
(12) Patent Application Publication
(10) Pub. No.: US 2026/0096572 A1
(43) Pub. Date: Apr. 9, 2026

(54) MELTABLE PLANT-BASED CHEESE

(71) Applicant: The Gardener Cheese Company, Inc., Kingston, NY (US)

(72) Inventors: Gary Smith, Glenview, IL (US); Alexander Smith, Glenview, IL (US); Michael Schwarz, High Falls, NY (US)

(21) Appl. No.: 19/102,488

(22) PCT Filed: Jun. 25, 2021
(86) PCT No.: PCT/US2021/039057

§ 371 Date: Feb. 10, 2025

Related U.S. Application Data
(60) Provisional application No. 63/046,099, filed on Jun. 30, 2020.

(51) Int. Cl. A23C 20/02; A23L 29/212; A23L 33/115; A23L 33/135; A23L 35/00

(52) U.S. Cl. CPC A23C 20/02; A23L 29/212; A23L 33/115; A23L 33/135; A23L 35/10

(57) ABSTRACT

A plant based cheese is made of a protein such as cashew protein, liquid low saturated fat vegetable oil, cultures and modified food starches. The ingredients are combined to form an emulsion, which is heated and held at a selected temperature for a selected time such that starches gelatinize. Shear is applied to the emulsion. The emulsion is liquid at the selected temperature but when cooled, the emulsion becomes solid. In its solid state, when it is heated, the product melts, closely resembling certain dairy cheeses. The liquid oil has relatively low saturated fat.

### BACKGROUND

In recent years the demand for plant-based substitutes for dairy products has increased dramatically. This has been driven by concerns about the environment, animal rights and human health. Animal agriculture is one of the leading cause of climate change and causes serious environmental pollution due to animal waste, including feces, urine, offal and blood. Dairy cows, with a life expectancy of about 25 years are routinely slaughtered after five years. Their male calves are killed for veal and they are kept in a constant cycle of lactation and pregnancy through forced insemination. This is both cruel and economically inefficient. Cows used in large scale agriculture are often fed with grains and pulses that are grown for the sole purpose of nourishing them so they can produce milk and then be slaughtered. The resources involved in growing those products would be more efficiently deployed to produce food for direct human consumption rather than putting them through animals. In addition, livestock consume vast quantities of water that would be more efficiently deployed for irrigating crops. Dairy products and meat which is a by-product of the dairy industry are associated with a variety of health issues in humans, including cardiovascular disease, prostate cancer, bone loss, diabetes and obesity. A growing number of people suffer from allergies to casein and lactose intolerance, both of which cause significant discomfort.

There is therefore a need for substitutes for animal products to feed human beings, particularly dairy cheese. This situation presents some significant challenges. Many of the appealing qualities of dairy cheese are attributable to casein and lactose, both found in cow's milk but not in plants. The former is a highly complex protein that causes dairy cheese to melt and stretch. The latter is a sugar that facilitates fermentation which imparts complex flavors to dairy cheese.

Several efforts have been made to produce non-dairy cheese. For example, cheeses have been made by compositions of soy protein, fermented cashew nuts and coagulated almond milk. While these often produce satisfying flavors and textures, they generally do not melt the way many dairy cheeses such as cheddar and mozzarella do. Another approach has been the use of food starch and coconut oil. These ingredients facilitate melting and stretching. The leading manufacturers of this type of product are Violife and Daiya. Other vegan cheese, such as those from Parmela Creamery and Miyoko's, also rely on starch and coconut oil but contain added proteins such as beans, pea protein isolate, oats and cashew nuts.

Coconut oil based vegan cheeses tend to have less than ideal flavor profiles due to the dominance of the coconut flavors. But the main drawback of these products is that coconut oil has very high levels of saturated fat. Saturated fat is considered to be very bad for human health, being associated with increased risks of cardiovascular disease. Dairy cheese also typically has high levels of saturated fat. The use of proteins such as beans and pea protein isolate presents some flavor challenges due to the bitter aftertaste they impart. These products may also have adverse effects on texture.

There is therefore a need for a plant-based cheese that has the flavor and melting characteristics of dairy cheeses such as cheddar and mozzarella, an acceptable level of protein, but which does not have high levels of saturated fat. Hydrogenated oils may be solid at room temperature, like coconut oils, but they too have serious health drawbacks and are out of favor with consumers.

### SUMMARY

The present disclosure provides a plant-based cheese which has the appealing flavor and texture of dairy cheeses and has an acceptable level of protein. It is solid at room and refrigerated temperatures and melts when heat is applied, for example, to make grilled cheese sandwiches and pizza or to top burgers, baked ziti or nachos. It does this without the use of high saturated fat oils like coconut oil.

In an embodiment of the disclosure, a 1 ounce (approximately 28 gram) serving has one gram of protein (3.5% of the product by weight). This protein is achieved by using cashew nuts at a level of about 10 to 20% by weight. Faba beans, pea protein, navy beans or garbanzo beans may also provide protein, alone or in combination with each other and with cashew nuts. Cashew nuts tend to produce the best flavor and texture when the cheese is cold and when it is melted.

The plant-based cheese of the present disclosure can be sliced, shredded and melted. It is made up of protein (preferably cashew nuts), water, cultures, starch, a low saturated oil, relative to coconut oil that is liquid at refrigerated temperatures and flavoring, including sodium chloride. The ratio of (moisture+fat)/starch solids is in a range between 3.8 and 5.0 (preferably 4.2). The cultures are preferably L. casei, L. bulgaricus and S. thermophilus in a ratio of approximately 5:1:1. It will be appreciated that these ratios may vary. The oil is preferably a high oleic expeller pressed sunflower oil. The exact oil may also vary.

The cheese may also comprise at least one salt selected from sodium chloride, calcium carbonate and calcium sulfate.

These and other advantages and features of the present invention are further described in the Detailed Description.

### DESCRIPTION OF THE DRAWINGS

FIG. 1 is a block diagram overview showing the basic process flow of the present disclosure:

FIG. 2 is a block diagram showing the culturing process of the present disclosure;

FIG. 3 is a block diagram showing the blending, heating, cooling and filling steps of the present disclosure;

FIG. 4 is a block diagram showing the conversion steps of the current disclosure.

### DETAILED DESCRIPTION

The following is a detailed description of the preferred embodiment of the disclosure. The description is not intended to be limiting of the disclosure, the full scope of which will be determined by the claims as properly interpreted.

The disclosure includes a vegan cheese base that is the starting point for a variety of flavors and textures. In order to achieve the goals of being solid at room and refrigerated temperatures and being able to melt at about 100° F. to 140° F., without the use of high saturated fat or hydrogenated oils, the selection of ingredients and their ratios to each other is controlled. Flavorings are added to the base and variations or additions to ingredients are made in order to create cheeses that resemble their dairy counterparts.

An embodiment of the base contains the following ingredients in the following ranges (by weight): Cashew nuts (5 to 30%); starch, preferably modified food starch (15 to 20%) which may include colloidal starch; oil, preferably high oleic expeller pressed sunflower oil (8 to 25%); and other proteins such as faba bean, navy bean, garbanzo bean or pea protein isolate (0 to 15%). In order to achieve the desired flavor and acidity, cultures may be added, for example Lactobacillus bulgaricus, Lactobacillus casei, Streptococcus thermophilus or Lactobacillus acidophilus. A ratio of 5 parts Lactobacillus casei to 1 part Lactobacillus bulgaricus to 1 part Streptococcus thermophilus is one option.

The use of these cultures surprisingly results in the cashew milk attaining flavors and aromas reminiscent of dairy cheese. Flavors may also be added for example, natural cheddar flavor, herbs, garlic or peppers. Lactic or citric acid may also be added to achieve the desired acidity (pH) and flavor profile. In order to achieve a desired water activity to act as a barrier against anaerobic bacteria and facilitate modified atmosphere packaging and for flavor, salts of various types may be added, for example, sodium chloride, calcium carbonate or calcium sulfate. Varying the ratio of protein (including cashew nuts) to starch and oil will result in changes in the melt characteristics and may have adverse impacts on flavor and texture. Colorants, for example, annatto, may be added to create familiar dairy cheese hues. The culturing process is illustrated in FIG. 2.

The starch performs the following functions. It assists with: (1) providing hardness at refrigerated and room temperatures and with melting, (2) building viscosity, and (3) emulsifying and building the body of the product. One embodiment uses the following starches (percentages shown in parentheses), all available from Emsland Group: (1) hardness and melt: Emes EOA 30 (F 7212) (13-16%); (2) viscosity: Emflo 991 (2.2-2.3%), and (3) emulsifying and body: Emfix K 02 (1.9%). Specific formulations are shown in Appendices A-D. Different starches in different proportions can be used to perform each or both of those functions.

For a cashew-based cheese, any raw cashew nuts can be used. Brazilian cashews are selected for flavor and ethical reasons. Broken pieces, P1 grade, are selected to make comminution easier. High oleic expeller pressed sunflower oil is considered healthier than low oleic chemically extracted oil.

A description of the ingredients used in the embodiment of a cheddar version of the plant-based vegan cheese of the present disclosure is set out in Appendix A, incorporated herein by reference.

A description of the ingredients used in the embodiment of a mozzarella version of the plant-based cheese of the present disclosure is set forth in Appendix B, incorporated herein by reference.

A description of the ingredients used in the embodiment of a pepper jack version of the plant-based vegan cheese of the present disclosure is set out in Appendix C, incorporated herein by reference.

A description of the ingredients used in the embodiment of a smoked provolone version of the plant-based vegan cheese of the present disclosure is set out in Appendix D, incorporated herein by reference.

The following is a description of a preferred method of making an embodiment of the disclosure.

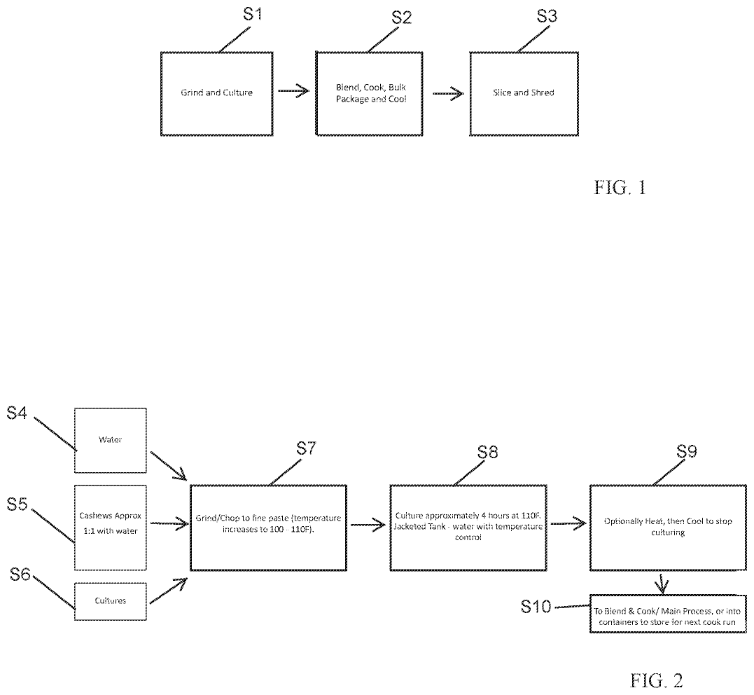

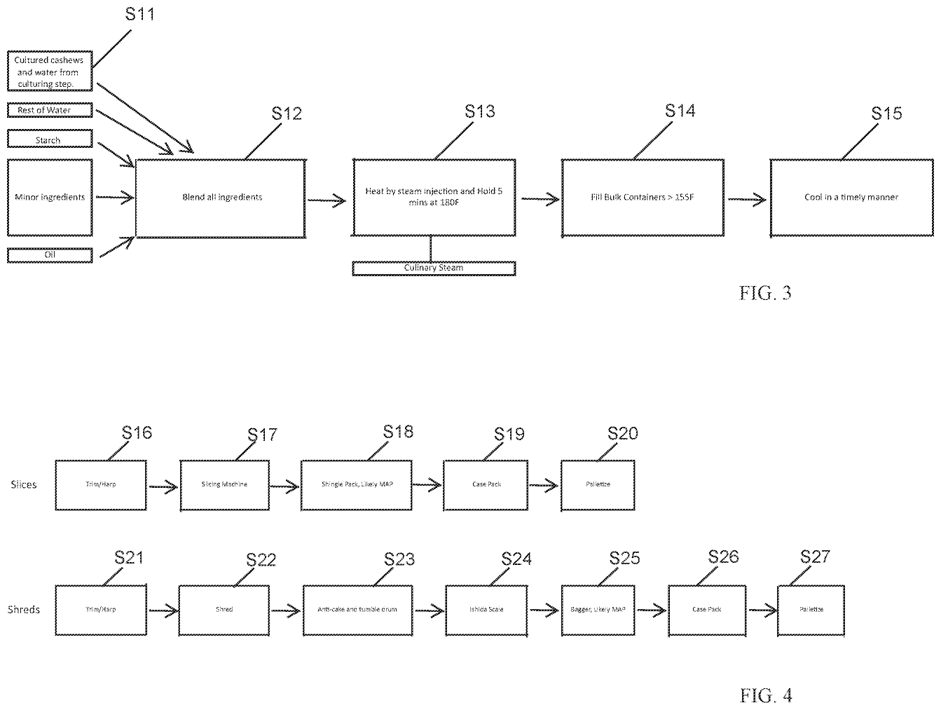

FIGS. 1 to 4 illustrate the process steps described in the following description.

The basic process flow of the present invention are shown in FIG. 1. In S1, cashew nuts (and or another protein) are ground up and cultured by adding cultures as described herein. The nuts may be pre-soaked before grinding. Step S2 involves blending the various ingredients including the cultured product made in S1, cooking the blend, packaging the cooked blend in bulk (typically blocks) and cooling the packaged product. In S3, the packaged product is sliced or shredded depending on the desired format of the cheese. These steps will be explained in further detail below.

FIG. 2 shows the culturing process using cashew nuts. The cashew nuts are finely ground with approximately the same weight of water as cashew nuts to make a cashew milk. A ratio of up to about 2.5:1 water to cashews will also work. In one embodiment, the cashews are soaked for several hours so they will soften. The cultures are added and the mixture is blended thoroughly. A lower amount of water can be used at this step, but that water will have to be added at a later step to ensure the right consistency. See S4, S5 and S6.

The temperature of the mixture should be in the range of approximately 95° F. to 115° F. to support growth of the cultures. See S7. The mixture is then covered and left at a temperature of about 100° F. to 110° F. for approximately four hours, or until it reaches the preferred aciditiy (pH) of about 5 to 5.2 often associated with dairy cheeses such as cheddar. The result is a cultured cashew milk with a mild flavor reminiscent of dairy milk. See S8 and S9.

When the cashew milk has cultured, it is blended with the rest of the ingredients in a blender and then heated in a cooking vessel with agitation. See S10. It is preferred to inject culinary steam to avoid burn on. The oil can be added gradually to help form an emulsion and control the color. The mixture is thoroughly blended and heated to 180° F. for five minutes. See 11, S12 and S13. The target acidity (pH) is reached by adding small amounts of lactic acid.

After it has been blended and heated for five minutes, the mixture is then transferred to a bulk container and refrigerated. S14. A block of cheese is thus formed weighing, for example, about 40 lbs. It should be cooled at a rate appropriate to prevent the growth of pathogenic bacteria. S15. Once the mixture has cooled it can be cut into loaves, sliced or shredded using typical dairy cheese converting equipment. Using cashew nuts as the main source of protein results in a ratio of (moisture+liquid fat) to starch solids of approximately 4.2. The product remains solid at refrigerated and room temperatures and starts to melts at between 95° F. and 140° F.

Step S3 is shown in greater detail in FIGS. 4. S15 to S19 are the steps involved in creating slices. The blocks are trimmed and harped to loaves sized suitably for a slicing machine. The loaves are sliced at S17. The resulting slices are shingled and then placed on a packaging machine like a roll stock thermoforming machine with modified atmosphere packaging (MAP) capability. The cheese slices are thereby vacuum packed or the air in the package is replaced with nitrogen or a nitrogen, carbon dioxide blend. At S19 and S20, the cheese packages are placed in cases and the cases are palletized.

S21 to S27 are the steps involved in creating shredded cheese. The blocks are trimmed and harped to loaves sized suitably for a slicing machine (S21). The loaves are shredded at S22. An anti-caking agent such as cellulose is applied to the resulting shreds at S23. The shreds are then weighed into bags and the bags are sealed at S24 to S25. The bagging involves modifying the atmosphere in the bags, for example by removing the air and fluxing the bags with nitrogen or a nitrogen, carbon dioxide blend. At S26 and S27, the cheese packages are placed in cases and the cases are palletized.

The disclosure comprises a non-dairy cheese product and a method of making a non-dairy cheese product.

The non-dairy cheese product of the present disclosure is solid at room temperature and melts when heated. It is made up of an emulsion including a protein base making up about 2% of the emulsion by weight, water, oil selected from oils ordinarily liquid at room temperature. The oil is preferably high oleic expeller pressed sunflower oil, selected for its heart-healthy characteristics. This oil is ordinarily liquid at room temperature. It has saturated fat significantly lower than that of oils that are solid at room temperature, specifically coconut oils. The emulsion also includes modified starch that gelatinizes when heated with the oil.

The protein base is cultured using one or more bacterial cultures, the addition of which to the protein base reduces the acidity (pH) of the protein base. The cultures are preferably at least one culture selected from: Lactobacillus casei, Lactobacillus bulgaricus, Streptococcus thermophilus.

The protein base may be a nut, pea, drupe or legume (for example cashew). Protein isolates may also be used.

The food starch may be a combination of modified food starches selected to provide hardness, melt, viscosity, emulsion and body.

The product very closely resembles certain dairy cheeses in that it melts when heated and is solid when at room temperature.

The method of the present disclosure has the steps of selecting ingredients comprising a protein base (comprising cashew nuts), water, modified food starch and oil. This oil, preferably high oleic expeller pressed sunflower oil, is liquid at room temperature and has saturated fat lower than oils that are solid at room temperature, specifically coconut oils. When mixed, but prior to processing, the selected ingredients are liquid at room temperature.

The protein base is cultured before adding it to the emulsion, using bacterial cultures selected from Lactobacillus casei, Lactobacillus bulgaricus, Streptococcus thermophilus. This lowers the acidity (pH) to a range of about 4 to 5.

An emulsion is formed from the ingredients by mixing them. Heat is applied to gelatinize the starch. Shear is applied at a rate of between approximately 500/sec and approximately 1000/sec. The emulsion is held at about 180° F. for sufficient time for the food starch to gelatinize. This may be about five minutes. The emulsion is then cooled to room temperature. The result is a product that closely resembles some dairy cheeses and is solid at room temperature but which melts when heat is applied to it.

APPENDIX A
CHEDDAR

| Ingredient | % in formula |
|---|---|
| Water | 45.17 |
| Cashews - Brazilian P1 Grade Raw | 20.00 |
| Modified Starch, Hard texture when refrigerated, | 15.35 |
| melts when heated | |
| Sunflower Oil - High Oleic Expeller Pressed | 12.00 |
| L. Casei | 0.05 |
| L. Bulgaricus | 0.01 |
| S. Thermophilus | 0.01 |
| Modified Starch, builds viscosity | 2.20 |
| Calcium Sulfate Dihydrate | 0.95 |
| Modified Starch, Emulsifies and builds body | 1.90 |
| Konjac, Xanthan gum blend where Konjac | 0.13 |
| comprises between .07% to .12% and Xanthan | |
| comprises the remainder | |
| Sodium Chloride | 1.70 |
| 44% Lactic Acid | 0.12 |
| Yeast Extract | 0.29 |
| Annatto | 0.04 |
| Cheddar Flavor | 0.08 |
| | 100 |

APPENDIX B
MOZZARELLA

| Ingredient | % in formula |
|---|---|
| Water | 46.53 |
| Cashews - Brazilian P1 Grade Raw | 20.00 |
| Modified Starch, Hard texture when refrigerated, | 15.35 |
| melts when heated | |
| Sunflower Oil - High Oleic Expeller Pressed | 12.00 |
| L. Casei | 0.05 |
| L. Bulgaricus | 0.01 |
| S. Thermophilus | 0.01 |
| Modified Starch, builds viscosity | 2.20 |
| Modified Starch, Emulsifies and builds body | 1.90 |
| Konjac, Xanthan gum blend where Konjac | 0.13 |
| comprises between .07% to .12% and Xanthan | |
| comprises the remainder | |
| Sodium Chloride | 1.60 |
| 44% Lactic Acid | 0.12 |
| Yeast Extract | 0.10 |
| | 100 |

APPENDIX C
PEPPER JACK

| Ingredient | % in formula |
|---|---|
| Water | 42.75 |
| Cashews - Brazilian P1 Grade Raw | 20.00 |
| Hard texture when refrigerated, melts when | 13.40 |
| heated | |
| Sunflower Oil - High Oleic Expeller Pressed | 12.00 |
| L. Casei | 0.05 |
| L. Bulgaricus | 0.01 |
| S. Thermophilus | 0.01 |
| Modified Starch, builds viscosity | 2.20 |
| Modified Starch, Emulsifies and builds body | 1.90 |
| Konjac, Xanthan gum blend where Konjac | 0.13 |
| comprises between .07% to .12% and Xanthan | |
| comprises the remainder | |
| Sodium Chloride | 1.60 |
| 5% Vinegar (optional) | 0.00 |
| Yeast Extract | 0.25 |
| Jalapeno Peppers (drained) | 3.89 |
| Pepper Juice | 1.11 |
| Natural Pepper Flavor | 0.70 |
| | 100 |

APPENDIX D
SMOKED PROVOLONE

| Ingredient | % in formula |
|---|---|
| Water | 45.95 |
| Cashews - Brazilian P1 Grade Raw | 20.00 |
| Hard texture when refrigerated, melts when heated | 15.65 |
| Sunflower Oil - High Oleic Expeller Pressed | 12.00 |
| L. Casei | 0.05 |
| L. Bulgaricus | 0.01 |
| S. Thermophilus | 0.01 |
| Modified Starch, builds viscosity | 2.30 |
| Emfix K02 Starch | 1.90 |
| Konjac, Xanthan gum blend where Konjac | 0.13 |
| comprises between .07% to .12% and Xanthan | |
| comprises the remainder | |
| Sodium Chloride | 1.70 |
| 44% Lactic Acid | 0.12 |
| Yeast Extract | 0.12 |
| Annatto | 0.01 |
| Smoke Flavor | 0.05 |
| | 100 |

What is claimed is:

30. A method of making a non-dairy cheese product that is solid at room temperature and melts when heated and becomes solid again when returned to room temperature, comprising the steps of:
forming a plant protein base comprising cashew nuts,
forming a cultured protein base by a method comprising the steps of:
inoculating the plant protein base with microbial cultures, selected from Lactobacillus casei, Lactobacillus bulgaricus, and Streptococcus thermophilus;
incubating the selected cultures, thereby reducing the pH of the protein base to a range of approximately 4 to approximately 5, and thereby imparting a dairy cheese flavor to the protein;
forming an emulsion comprising:
the cultured protein base,
food starch selected to provide gelatinization, viscosity and body, and
oil that is liquid at room temperature and has a saturated fat content lower than that of coconut oil;
applying shear to the emulsion;
gelatinizing the emulsion by heating it;
cooling the emulsion to room temperature.

31. The method of claim 30 wherein the step of gelatinizing includes the step of holding the emulsion at approximately 180° F. for approximately five minutes.

32. The method of claim 31 further comprising the step of soaking the cashew nuts to soften them prior to grinding.

33. The method of claim 30 wherein the shear is at a rate of at a rate of between approximately 500/sec and approximately 1000/sec.

34. A non-dairy cheese product that is solid at room temperature, melts when heated and solidifies when returned to room temperature, the product comprising:
an emulsion including:
a cultured protein base comprising cashew nuts, inoculated with bacterial culture including Lactobacillus casei, Lactobacillus bulgaricus, and Streptococcus thermophilus, added to the cashew nuts, and incubated, thereby reducing the pH of the protein base to a range of approximately 4 to 5, and imparting a dairy cheese flavor to the cultured protein base;
oil selected from oils that are liquid at room temperature, the selected oil having lower saturated fat than coconut oil;
starch, including starch that gelatinizes when heated with the oil, and starch to provide hardness, viscosity and body,
wherein the emulsion is gelatinized by heating it;
wherein, after cooling to room temperature, the emulsion becomes solid, melts when heated and becomes solid again at room temperature.

35. The product of claim 34 wherein the emulsion has been subjected to shear prior to cooling.

36. The product of claim 35 wherein the shear is in a range of approximately 500/sec and approximately 1000/sec.

37. The product of claim 34 wherein the cultured cashew base provides the finished emulsion with approximately 2% protein by weight.
